(19) United States
(12) Patent Application Publication
(10) Pub. No.: US 2015/0240977 A1
(43) Pub. Date: Aug. 27, 2015

(54) Flow Valve With Components Which Prevent Interchangeability

(71) Applicants: Edwin John William Zonneveld, Fort Langley (CA); Kelly Maxwell Stead, Maple Ridge (CA)

(72) Inventors: Edwin John William Zonneveld, Fort Langley (CA); Kelly Maxwell Stead, Maple Ridge (CA)

(21) Appl. No.: 14/187,306

(22) Filed: Feb. 23, 2014

(51) Int. Cl. F16L 29/04

(52) U.S. Cl. CPC F16L 29/04

(57) ABSTRACT

A flow valve having a male flange for joining an adjacent female coupling valve or pipe section to form a continuous fluid conduit. The flow valve having a replaceable flange which is used for connecting one fluid conduit to another to form a continuous flow path where the flange has components which prevent interchangeability. A female coupling valve or pipe section defining a duct for communication of a fluid with a locking arrangement for locking the male flow valve in the adjacent female coupling valve or pipe section. Protrusions are provided on either an inside surface of the female coupling valve or pipe section or on an outside surface of the flow valve flange and corresponding recesses are provided on the other with the recesses and protrusions being cooperatively shaped arranged to allow insertion of the flow valve into the female coupling valve or pipe section to the locking position only when said at least one recess and said at least one protrusion match.

### BACKGROUND

1. Field

This application relates to a flow valve having a flange for joining an adjacent coupling valve or pipe section to form a continuous fluid conduit and specifically to a flow valve having a replaceable flange which is used for connecting one fluid conduit to another to form a continuous flow path where the flange has components which prevent interchangeability.

2. Prior Art

In U.S. Pat. No. 5,407,175 a flow valve with a replaceable flange is disclosed. The replaceable flange, also called a nose ring, provides a bearing surface at the end of the flow valve for joining an adjacent coupling valve or pipe section to form a continuous fluid coupling. The replaceable flange can be removed and repositioned to distribute wear or replaced when the flange is worn. The replaceable flange disclosed does not include components which prevent interchangeability or features which permit easy removal or repositioning without tools.

In Canadian Patent No. 2800795 a quick disconnect coupling with protrusions and recesses shaped and arranged to allow mating of the male and female halves of the coupling is disclosed. The coupling can only be assembled when the protrusions on one half matches the recesses on the other half of the coupling. The system of couplings disclosed relies on a separate camlock adapter coupling to transition from a standard API valve to a configured end on the coupling with protrusions or recesses. This coupling is called a tag adapter since it is used to tag the API valve with a fuel specific coupling after the fuel is loaded into the tanker. This system of couplings does not disclose how to pre-tag the API valve for a particular fuel so that only that fuel can be loaded and subsequently unloaded from the API valve.

Flow valves with fixed or replaceable flanges are used in many applications and industries such as loading tankers at fuel terminals and unloading fuel from tankers into underground storage tanks at gas stations. A typical tanker will carry a combination of diesel fuel, various grades of gasoline and ethanol based fuels. Each flow valve, also called an API valve in the fuel delivery industry, is fixed to the tanker and communicates with its associated storage compartment on the tanker. The API valve is used to bottom load fuel at the terminal with a mating bottom loading coupler. When unloading fuel a camlock style drop adapter is attached to the flow valve which permits connecting the required camlock hose assemblies and drop elbows to the service station storage tank top seal adapter. The flow valves, bottom loading couplers and drop adapters are the same size and design regardless of the fuel being loaded or unloaded and this can result in cross contamination or accidental mixing of fuels in both the tanker or more commonly in the storage tank at the gas station. For instance it is all too easy to load a tanker compartment with diesel and accidently unload this compartment into the regular gasoline storage tank at the gas station since all the coupling connections are identical regardless of the type of fuel. Even with procedures, color coding and labeling systems in place these fuel mixes or crossovers, as the industry refers to them, are all too common and costly to rectify. Diesel and gasoline mixes that end up in customer vehicles can result in expensive engine repairs and a serious loss of reputation in the marketplace for the oil company. Mixes can also result in motorist and boaters becoming stranded with engine failure which can be a serious safety issue and a potential liability concern for oil companies.

Standard API valves with or without replaceable flanges are not designed to prevent crossovers. Thus an API valve that uses replaceable flanges uniquely configured for each type of fuel to be loaded, carried and unloaded not only eliminates the potential for crossovers but also provides an important tagging function to clearly identify the fuel to be loaded into a particular tanker compartment, the fuel that is being carried in a particular tanker compartment and the fuel to be subsequently be unloaded from the particular tanker compartment at the service station. Prior to loading a tanker compartment a fuel specific replaceable flange or tagging ring for say diesel is installed on the appropriate API valve body. The tagging flange has a unique configuration of recesses or protrusions that are specific to the fuel to be loaded. With say a diesel tagging flange in place on the API valve only the API bottom loading coupler configured with matching protrusions or recesses for diesel will fit with the diesel tagging flange installed on the API valve. This creates a physical barrier that prevents an API bottom load coupler configured for any other type of fuel from mating with this API valve. Other tanker compartments are similarly tagged and loaded with the appropriate fuel. It is common for a tanker to carry three or more different fuels in a single load so it is critical to clearly identify the type of fuel carried in each compartment of the tanker. After loading all the compartments the tagging rings are left in place on the API valves and the API valves are capped for transport with standard camlock dust caps.

At the service station the driver will remove the camlock dust caps and install fuel specific drop adapters uniquely configured for each fuel with protrusions or recesses that will only match the corresponding tagged API valves. In Canadian Patent No. 2800795 a camlock style coupling with fuel specific tagging features is disclosed that can be used on the remaining camlock, hose assemblies, drop elbows and underground tank top seal fittings to provide a complete physical crossover prevention and tagging system for loading tankers at the terminal to unloading tankers at the service station.

Therefore an API valve with a fuel specific replaceable flange provides the missing feature that will prevent fuel crossovers by physically and visually tagging the API valve with the specific fuel to be loaded and unloaded. This and other advantages will become apparent from a consideration of the ensuing description and accompanying drawings.

### SUMMARY OF THE INVENTION

According to the invention there is provided a flow valve for mating with a female coupling comprising:

a generally annular flange member having components for mounting said annular flange member;

a generally cylindrical flow valve body having opposed ends, one of the opposed ends of said flow valve body defining a leading end having cooperating components to facilitate mounting said annular flange member;

a flow valve member comprising said annular flange member mounted to said flow valve body member.

a female coupling defining an opening into which a leading end of said flow valve member can be inserted so that the flow valve is moved longitudinally of an axis of the female coupling member into the opening to a locking position;

the flow valve member and female coupling member defining a duct passing therethrough for communication of a fluid therebetween;

a locking arrangement for locking the flow valve member in the female coupling member at the locking position;

wherein the locking arrangement includes a plurality of circumferentially spaced locking members within a respective inside opening of the female coupling member for movement radially inwardly of the axis of the female coupling member into locking engagement with a portion of said annular flange member;

cooperating components provided on an inside surface of said female coupling member and on an outside surface of said annular flange member;

said cooperating components comprising at least one protrusion provided on either an inside surface of the female coupling member or on an outside surface of the annular flange member;

said cooperating components comprising at least one recess provided on either an inside surface of the female coupling member or on an outside surface of the annular flange member;

said cooperating components defined by said at least one recess and said at least one protrusion being cooperatively shaped and arranged to allow insertion of the flow valve member into the female coupling member to the locking position when said at least one recess and said at least one protrusion match;

Preferably there is provided a plurality of protrusions and a plurality of recesses at a predetermined spacing therebetween and wherein insertion of the flow valve member into the female coupling member to the locking position is allowed only when said predetermined spacing matches. However a single protrusion and associated recess can be used where they are set at a predetermined angle around the coupling and/or have a predetermined dimension and height.

Preferably there are provided elements identifying the location of the protrusions and recesses when the flow valve and the female coupling member are connected and when they are separated so as to ensure alignment when relative movement is undertaken. That is the user can see the location of the elements to ensure that they are aligned as the user tries to insert the components or to separate.

That is for example the rotational and axial alignment for assembly and disassembly of the female coupling member can be made evident by way of the protrusions and recesses themselves and/or by the inclusion of additional alignment marks on the female coupling member and/or on the flow valve member.

The annular flange member is shaped for engagement with the locking arrangement of the female coupling member and the protrusions and recesses are located to prevent movement of the flow valve to the locking arrangement unless aligned. This allows that the female coupling member and the flow valve member can be rotated relative to each other after assembly. That is the recess and the protrusion do not cooperate with the locking arrangement to hold the components connected but act as a restriction to allow the locking arrangement to engage only when the recess and protrusion match.

Preferably the protrusions are located on the female coupling member and align with the space behind the annular flange member when the flow valve is moved to the locking position.

In particular the present invention is particularly designed for use with both;

a camlock drop adapter of the type in which the locking arrangement includes a plurality of hand operated cam members each having a lever within a respective side opening of the female coupling member and a cam portion passing through one of said side openings and engaging a portion of the flow valve annular flange member and each being pivotally connected to the female coupling member for outward movement of the levers away from the female coupling member to disengage the cam portions from the said portion of the flow valve annular flange member;

a bottom loading coupler of the type in which the locking arrangement includes a plurality of circumferentially spaced locking latches on the inside end of the body which are actuated simultaneously by a separate hand lever for movement of the locking latches to engage or disengage the flow valve annular flange member.

Preferably the matched protrusions and recesses are shaped and located so that they are not interchangeable with a coupling configured with a different configuration of protrusions and recesses.

Preferably the recess is formed by machining, casting, molding or other methods in the annular flange member of the coupling.

Preferably the protrusion is formed by a cast feature, a machined fastener, pressed in pin, molded or cast insert or by any other means or processes in the female coupling member.

Preferably the system allows for backwards compatibility with industry standard couplings. This can be achieved by the fact that one of the female coupling member and the flow valve annular flange member which carries the recesses can be used in an industry standard female coupling having no protrusions.

Preferably the flow valve with annular flange member and the female coupling member both have a circular cross-section. This allows rotation as mentioned above.

However the female coupling member and the flow valve member can have a common unique cross sectional shape different from circular. For example the cross-sectional shape can be square with rounded corners.

Preferably the cooperating component on the outside surface of the annular flange member is located at the leading end of the flow valve.

Preferably the annular flange member provides a visual and physical tagging function to identify the fuel to be loaded, carried and unloaded.

Preferably the annular flange member can be repositioned or reversed to distribute wear.

According to a further aspect of the invention there is provided a method of delivering a plurality of different fluids comprising:

providing for each fluid a respective delivery duct;

providing in each delivery duct a flow valve as defined above;

and arranging said at least one protrusion and said at least one recess of a first one delivery duct to have a different configuration from that of a second one of the delivery ducts to prevent interchangeability of the first and second delivery ducts.

### BRIEF DESCRIPTION OF THE DRAWINGS

Embodiments of the invention will be described hereinafter in conjunction with the accompanying drawings in which:

FIG. 1 is an isometric exploded view showing a flow valve body with a replaceable flange containing interlock recesses configured for a specific fuel. A bayonet style mounting with spring plungers to hold the replaceable flange in place is illustrated.

FIGS. 2A and 2B is an isometric and end view of the flow valve body with the replaceable flange rotated and aligned in preparation for engaging the bayonet positioning blocks on the replaceable flange with the bayonet groove in the flow valve body.

FIGS. 3A and 3B is an isometric and end view of the flow valve body and replaceable flange with the matching bayonet elements fully engaged axially but prior to rotation of the replaceable flange to the locking position.

FIGS. 4A and 4B is an isometric and end view of the flow valve body and replaceable flange with the matching bayonet elements fully engaged and rotated to the locking position where the spring plungers hold the replaceable flange in position thereby completing the assembly of the flow valve.

FIG. 5 is an end view of the flow valve with the replaceable flange fully installed and rotated to the locking position where the spring plungers hold the replaceable flange in position.

FIG. 6 is a cross sectional view of FIG. 5.

FIG. 7 is a cross sectional end view of FIG. 6 through the centerline of the spring plungers.

FIG. 8 is a cross sectional view of FIG. 7 through a plane aligned with two of the spring plungers.

FIGS. 9A and 9B shows an end and side view of the replaceable flange with the interlock recesses spaced X degrees apart. X=10 degrees for the Premium fuel configuration.

FIGS. 10A and 10B shows an end and side view of the replaceable flange with the interlock recesses spaced Y degrees apart. Y=20 degrees for the Diesel fuel configuration.

FIGS. 11A and 11B shows an end and side view of the replaceable flange with the interlock recesses spaced Z degrees apart. Z=30 degrees for the Regular fuel configuration.

FIG. 12 shows an isometric view of a tanker configured with multiple load/unload API flow valves.

FIG. 13 shows an isometric view of a tanker configured with multiple load only API flow valves and separate unloading valves below.

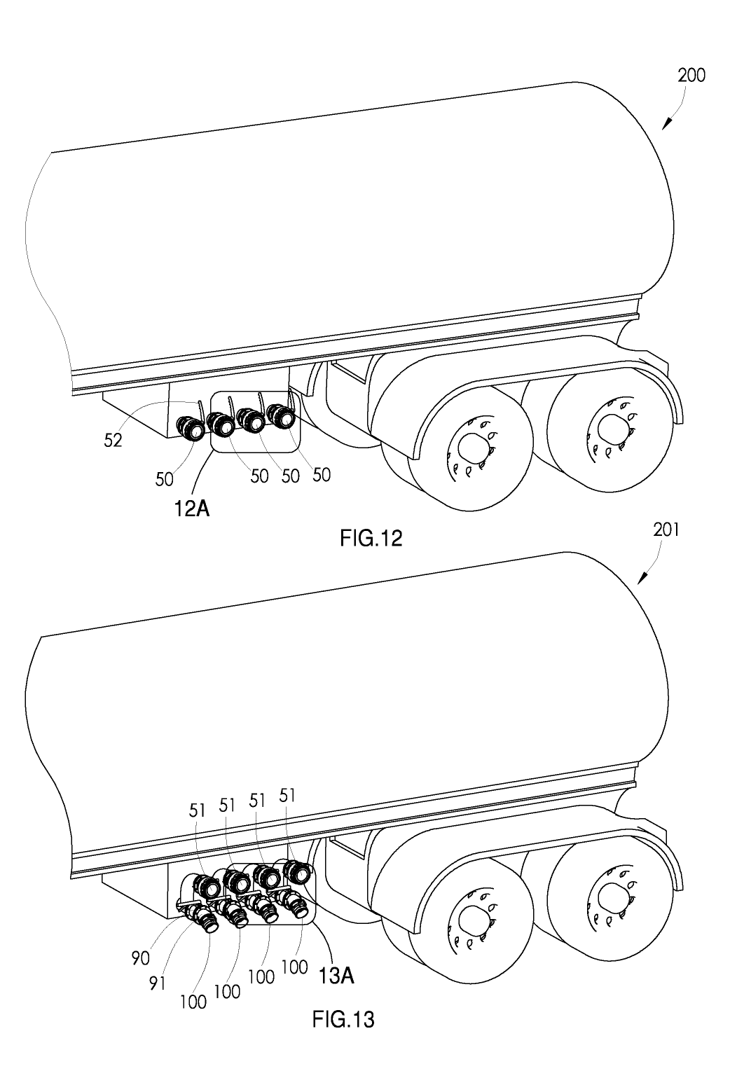

FIG. 12A shows an enlarged view of FIG. 12 showing multiple load/unload API valves with replaceable flanges configured for various types of fuel.

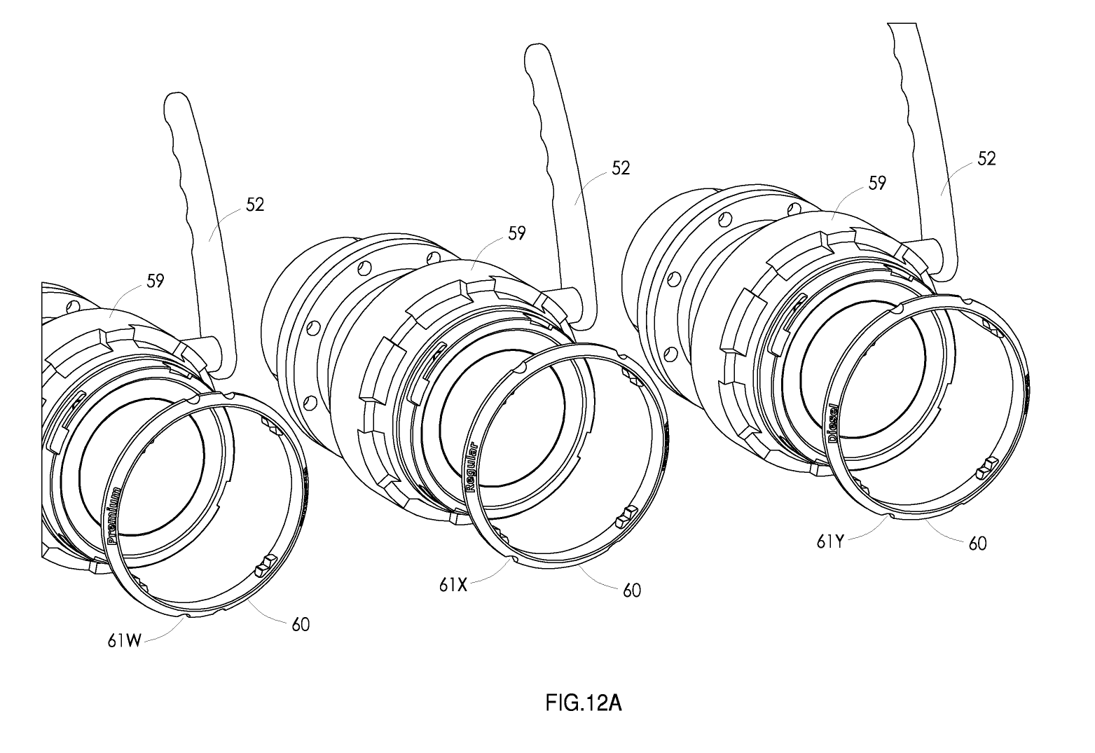

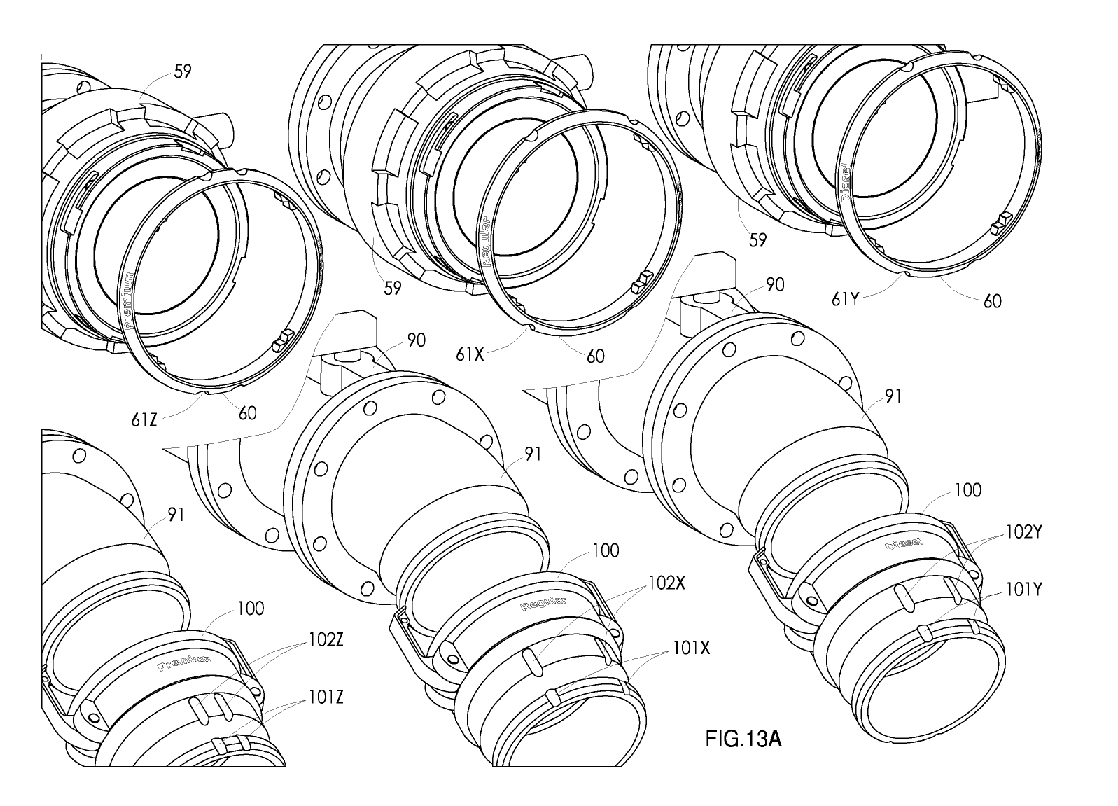

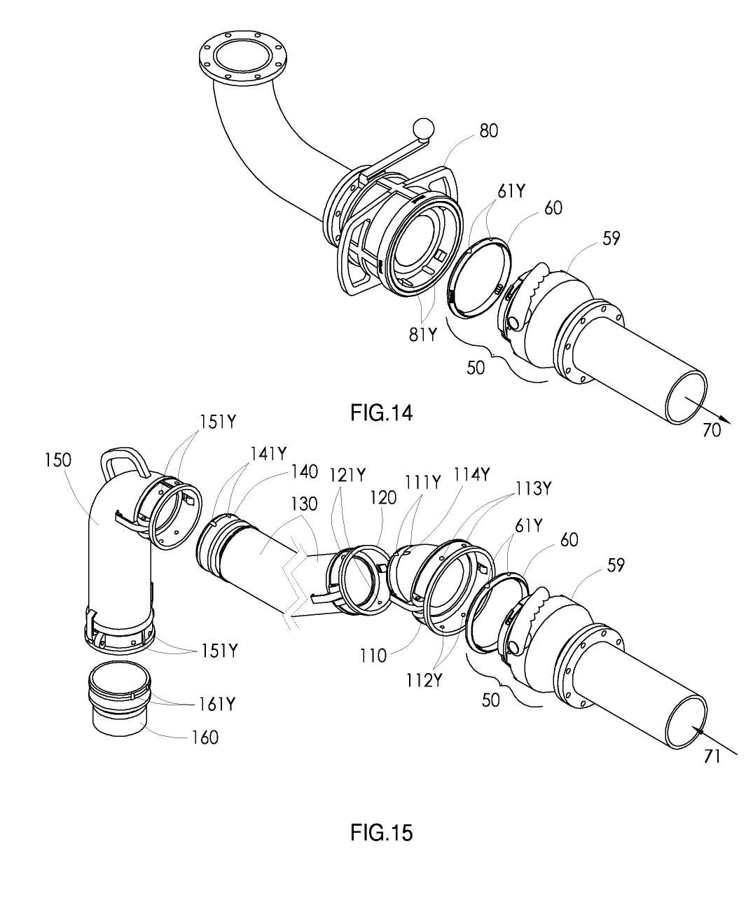

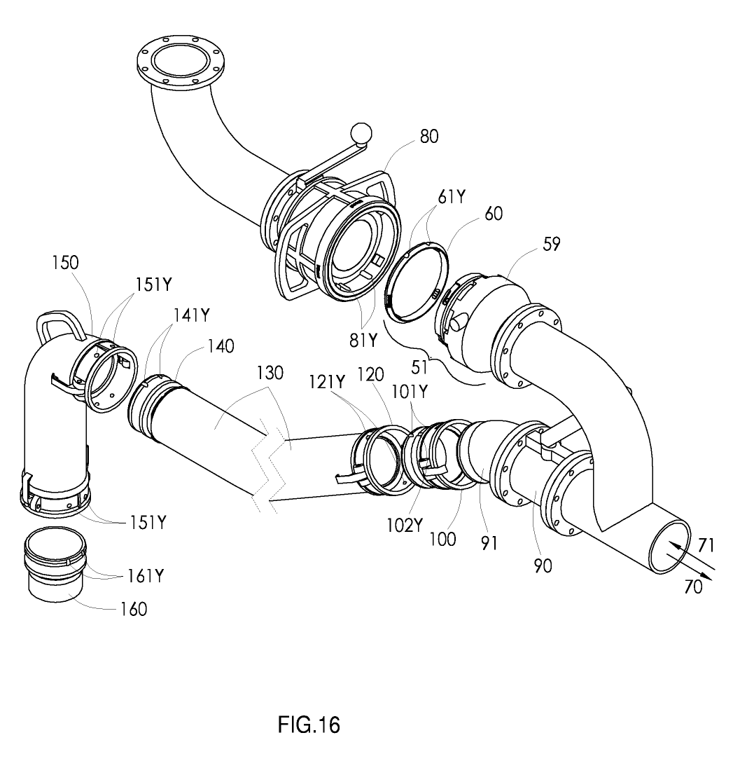

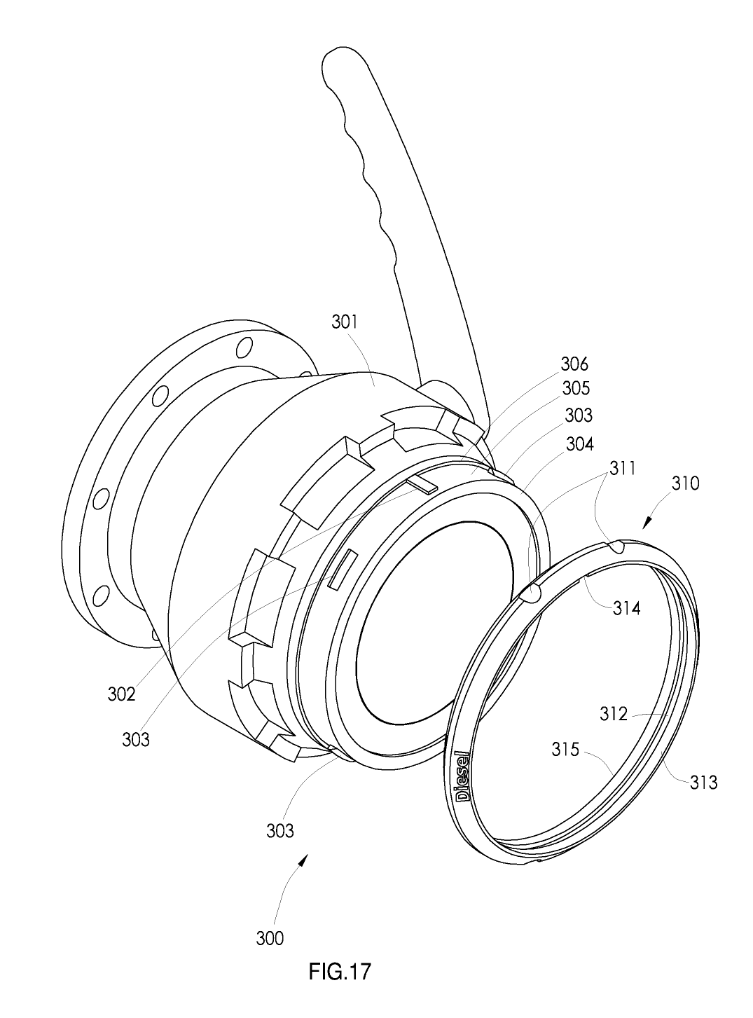

FIG. 13A shows an enlarged view of FIG. 13 showing multiple load only API valves with replaceable flanges configured for various types of fuel and separate unloading valves configured for the same fuels using tag adapter camlocks.

FIG. 14 shows an isometric exploded view of a tanker load/unload API valve configured with a fuel specific replaceable flange and a bottom loading coupler configured to mate with the fuel specific replaceable flange.

FIG. 15 shows an isometric exploded view of a tanker load/unload API valve configured with a fuel specific replaceable flange and all the interconnecting and configured hose and fittings required to unload fuel through the configured top seal male adapter mounted on the underground fuel storage tank.

FIG. 16 shows an isometric exploded view of a tanker load only API valve configured with a fuel specific replaceable flange and a bottom loading coupler configured to mate with the fuel specific replaceable flange. This figure also shows the isometric exploded view of the tanker unloading valve configured with a fuel specific, tag adapter camlock coupling and all the interconnecting and configured hose and fittings required to unload fuel through the configured top seal male adapter mounted on the underground fuel storage tank.

FIG. 17 is an isometric exploded view showing another embodiment of a flow valve body with a replaceable flange containing interlock recesses configured for a specific fuel. A slide-on mounting with a key and slot feature for alignment and spring loaded latches to hold the replaceable flange in place is illustrated.

### DRAWINGS

### Reference Numerals

50 API Valve or Flow Valve (load/unload) - with unloading handle.
51 API Valve or Flow Valve (load only) - without unloading handle.
52 Unloading Handle
53 Bayonet Groove
53A Annular Groove Opening
53B Annular Groove
53C Annular Groove End
54 Mounting Hole
55 Spring Plunger Assembly
56 Body
57 Spring
58 Ball
59 Flow Valve Body
59A Flow Valve Body Front Face or Leading End of Flow Valve
Body or Leading End of Assembled Flow Valve
60 Replaceable Flange or Nose Ring or Tagging Ring or Annular
Flange Member
61 Interlock Recess
62 Positioning Block
62A Lead-in Angled Ramps
62B Inner Angled Ramps
63 Label (e.g. Fuel Type)
64 Inner Annular Surface
70 Fuel Flow into tanker compartment
71 Fuel Flow out of tanker compartment
80 Bottom Loading Coupler
81 Protrusion (Bottom Load Coupler)
90 Unloading Valve
91 Unloading Valve Elbow
100 Camlock Tag Adapter
101 Interlock Recess
102 Alignment Recess
110 Drop Adapter
111 Interlock Recess
112 Interlock Protrusion
113 Alignment Protrusion
114 Alignment Recess
120 Female Hose Coupler
121 Interlock Protrusion
130 Hose
140 Male Hose Adapter
141 Interlock Recess
150 Drop Elbow
151 Interlock Protrusion
160 Top Seal Adapter
161 Interlock Recess
200 Tanker with Load/Unload API Valves
201 Tanker with Load Only API Valves
300 API Valve or Flow Valve (load/unload) - with unloading handle.
301 Flow Valve Body
302 Key
303 Spring Latch Assembly
304 Flow Valve Body Front Face or Leading End of Flow Valve
Body or Leading End of Assembled Flow Valve
310 Replaceable Flange or Nose Ring or Tagging Ring or Annular
Flange Member
311 Interlock Recess
312 Annular Groove
313 Inner Annular Surface
314 Slot

### DETAILED DESCRIPTION

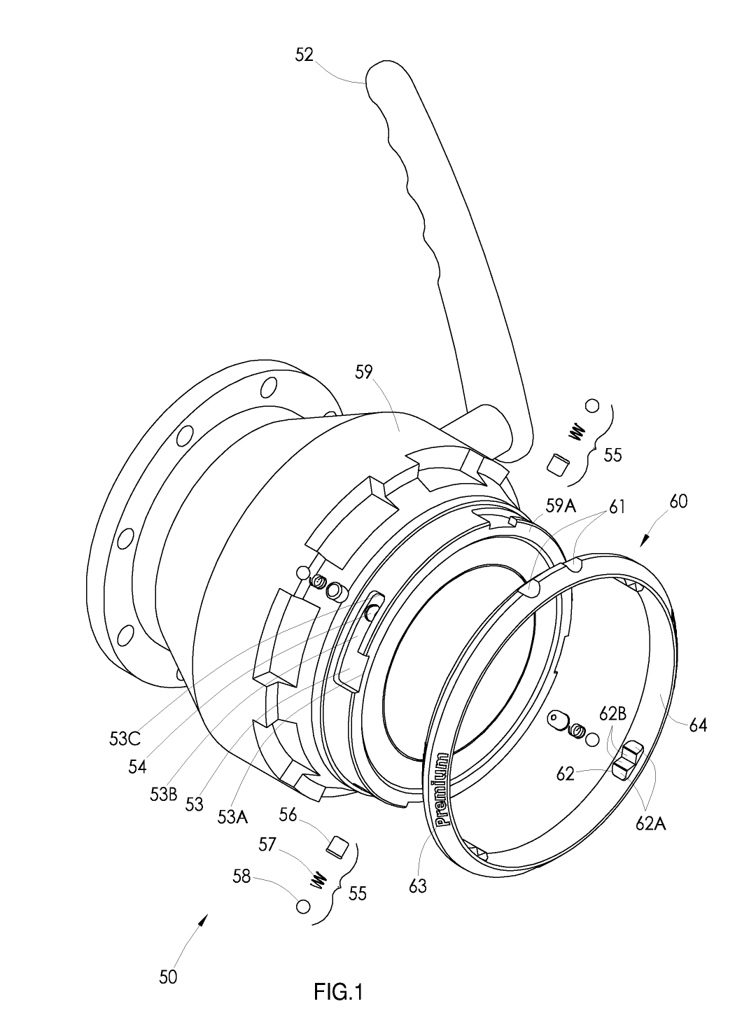

FIGS. 1-16 show one embodiment of a flow valve assembly 50 and 51 used to bottom load fuel into tankers and, in the case of flow valve 50, to also unload fuel from tankers into service station storage tanks. The replaceable flange or nose ring 60 includes one or more positioning blocks 62 which align and engage with bayonet grooves 53 and spring plungers 55 in flow valve body 59 to provide for quick assembly and disassembly of the replaceable flange 60. The replaceable flange 60 also includes interlock recesses 61 with an angular spacing specific to a particular fuel so that once assembled to the flow valve body 59 the flow valve assembly 50 will only mate with a configured bottom load coupler 80 and drop adapter 110 having a matching interlock protrusions 81 and 112 respectively as shown in FIGS. 14 and 15. The replaceable flange 60 together with its fuel specific interlock recesses 61 also provides a visual and physical tagging function to prevent loading the wrong fuel in the tanker and unloading the wrong fuel at the service station. These and other advantages will become apparent from a consideration of the ensuing detailed description and accompanying drawings.

FIG. 1 shows an exploded view of the flow valve 50 which includes a body portion 59 that contains the mechanics and sealing systems of the flow valve. Flow valves in use today include flanges that are integral to the housing 59 or flanges that are fixed to the housing using fasteners or other means that allow periodic replacement or repositioning in order to distribute wear on the flange faces.

The body portion 59 is cast and/or machined without a flange. In place of the flange a bayonet groove 53 is milled or cast directly into the housing 59. The bayonet groove 53 includes a partial annular opening 53A communicating with the front face of the valve body 59A and is sized to accept axial movement of the positioning block 62 located on the inner annular surface 64 of the replaceable flange 60.

The bayonet groove 53 includes an additional annular groove portion 53B that communicates with annular groove opening 53A and is sized to allow rotation of the replaceable flange 60 when positioning block 62 is aligned with annular groove 53B.

Annular groove portion 53B includes mounting hole 54 to accept the installation of spring plunger assembly 55 comprised of body 56, spring 57 and ball 58. The spring plunger 55 communicates with one of the lead-in angled ramp portions 62A of the positioning block 62 as the replaceable flange 60 is rotated towards the blind end of the bayonet annular groove 53C. At the end of this rotation the ball 58 of the spring plunger 55 comes to rest between the inner angled ramp portions 62B thereby positively locating the replaceable flange 60 in its installed position.

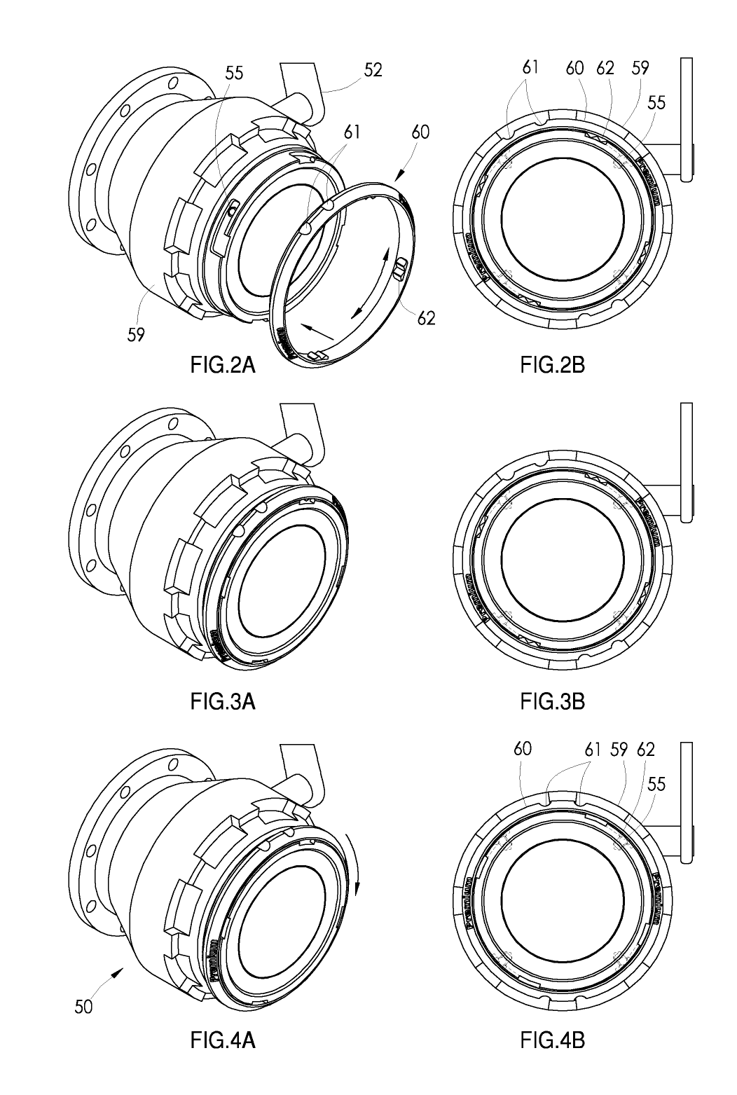

FIG. 2A and FIG. 2B shows the replaceable flange 60 rotated and aligned in preparation for axial assembly onto the valve body 59.

FIG. 3A and FIG. 3B shows the replaceable flange 60 axially installed on the valve body 59 prior to initiating rotation of the replaceable flange 60.

FIG. 4A and FIG. 4B shows the replaceable flange rotated into its final installed position. To remove the replaceable flange 60 simply reverse the steps above.

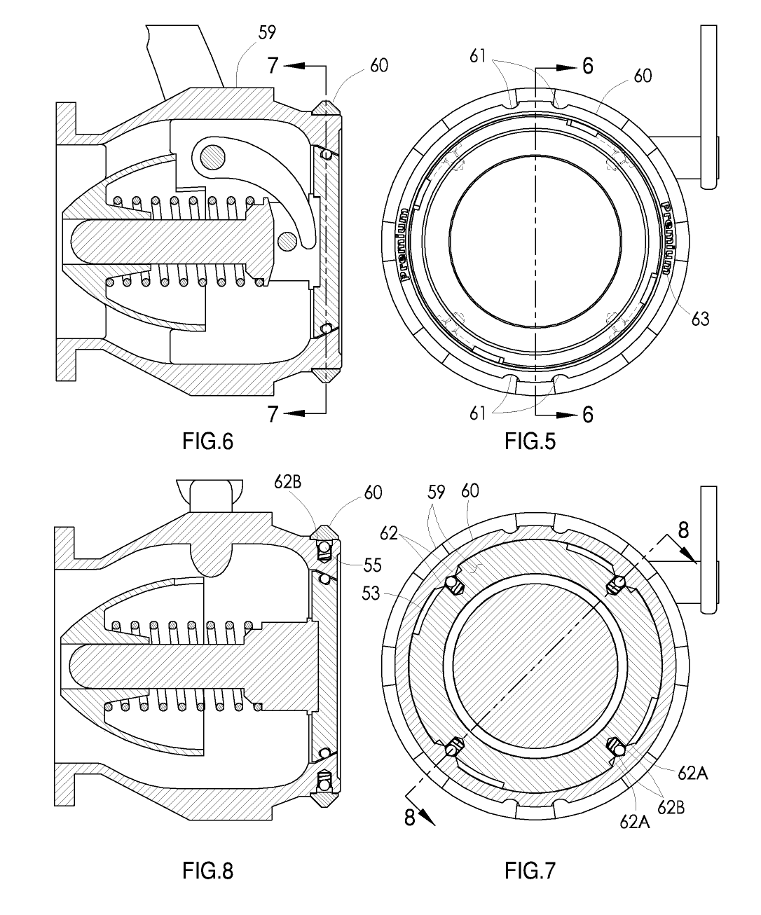

FIG. 5 is an enlarged view of FIG. 4B with three section views, FIGS. 6-8, derived from this view. These views all show the replaceable flange in its final installed position with the spring plungers 55 engaging their respective positioning blocks 62 on inner ramps portions 62B.

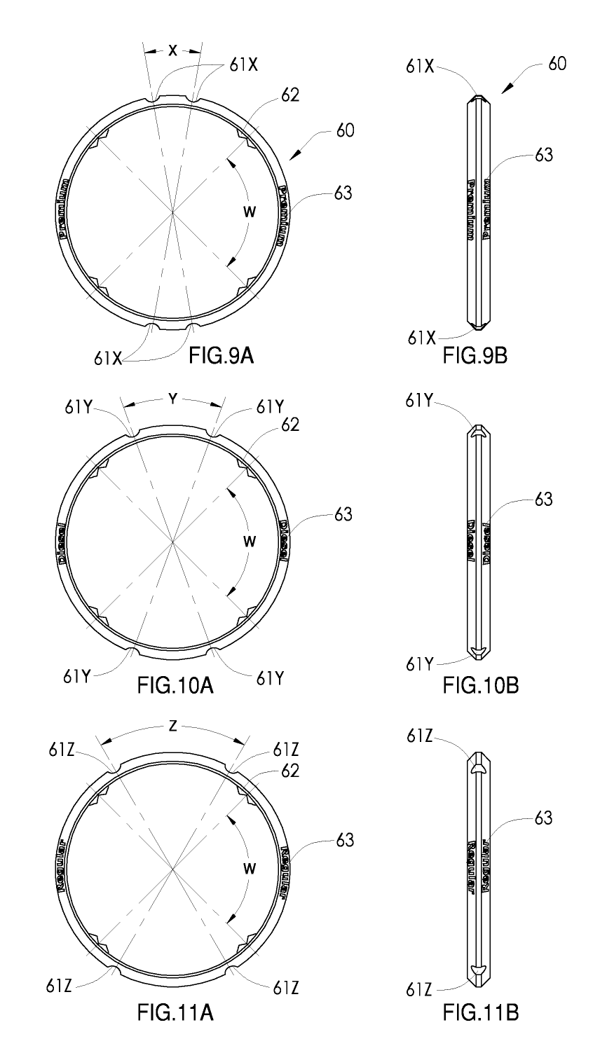

FIGS. 9A through 11B show an example of three unique angular configurations (X, Y & Z respectively) of the interlock recesses 61 located on the replaceable flange 60. The angular recess patterns (X, Y and Z) are repeated top and bottom (180 degrees apart) to provide a balanced feel when assembling or attaching the bottom load coupler 80 or drop adapter 110. FIGS. 9A and 9B represents Premium fuel with X=10 degrees, FIGS. 10A and 10B represents Diesel fuel with Y=20 degrees and FIGS. 11A and 11B represents Regular fuel with Z=30 degrees. A bottom load coupler 80 or drop adapter 110 configured with protrusions configured to match these recess configurations can only mate with each other when the protrusions and recesses match. For example a “Z” or Regular fuel configured bottom load coupler and drop adapter will only fit a flow valve with the same “Z” or Regular fuel configured replaceable flange. An X configured bottom load coupler and drop adapter will not mate with Y or Z configured flow valves and so on.

The positioning blocks 62 located on the replaceable flange 60 have the same angular location and spacing W regardless of the particular angular configuration of the interlock recesses X, Y & Z. FIGS. 9A through 11B show four positioning blocks 62 equally spaced or 90 degrees apart on each replaceable flange 60 so that each replaceable flange configuration X, Y or Z is interchangeable on the common flow valve body 59. The flow valve body 59 always has the same angular spacing and configuration W of the bayonet groove 53 regardless of the fuel to be loaded or unloaded. In this way the replaceable flange 60 with its particular configuration of interlock recesses 61 provides both a tagging function to clearly identify the fuel to be loaded and subsequently unloaded and a physical crossover prevention function by physically keying the bottom load coupler 80 and drop adapter 110 to the replaceable flange 60.

The positioning blocks 62 are shown as an integrally cast and/or machined feature of the tagging ring 60 however the positioning blocks 62 can also be a separate cast, molded, stamped or machined body that is fastened, pinned, bonded, welded or glued to the inner annular surface 64 of the tagging ring 60.

The industry currently relies on labeling procedures and color coding systems to help prevent incorrect connections between the tanker 200 or 201 and the underground storage tank at the service station. The labelling system typically takes the form of metal tags hung on a hook next to the API valve to remind the driver of the type of fuel contained in the tanker compartment communicating with this valve. Even with procedures and systems in place it is not uncommon for mixes or crossovers to occur. A premium gasoline and regular gasoline crossover will result in a costly downgrade of the premium fuel along with the time and expense to pump the downgrade into the regular grade storage tank. A diesel and gasoline mix is far more serious and expensive to rectify since the fuel is no longer useable as either gasoline or diesel and must be pumped out of the storage tank and disposed of. Diesel and gasoline crossovers that end up in vehicles can cause severe damage to fuel systems and engines and lead to expensive repairs along with a loss of reputation in the marketplace for the oil company that can result in further lost revenue. Mixes can also result in motorist and boaters becoming stranded with engine failure which can be a serious safety issue and a potential liability concern for oil companies.

FIG. 12 shows a tanker 200 configured with API valves 50 used to load and unload fuel. API valves 50 include an unloading handle 52 used to unload fuel.

FIG. 13 shows a tanker 201 configured with API valves 51 used to only load fuel. A handle is not used on flow valve 51 since a separate unloading valve 90 and drop elbow 91 is provided for this purpose.

FIG. 12A shows an enlarged exploded view of FIG. 12 showing multiple load/unload API valves 50 with replaceable flanges 60 configured for various types of fuel. A replaceable flange 60 must be installed on the valve body 59 to complete the flow valve assembly 50 before any fuel can be loaded into the tanker. The replaceable flange 60 remains in place on the flow valve at all times and until all fuel is unloaded and the tanker returns to the terminal for another load of fuel. Only when the tanker is empty and at the terminal will the replaceable flanges 60 be removed and replaced with replaceable flanges configured for different fuels. Of course if the tanker compartments will be filled with the same fuels as on the last run then there is no need to remove the replaceable flanges since the flow valves are already configured correctly.

Because the replaceable flanges or tagging rings 60 can be rotated 90 or 180 degrees or reversed the life expectancy of the replaceable flange is greatly extended and since the replaceable flange is replaceable the life of the valve body is also greatly extended. This greatly extends the life of the load/unload flow valves 50 on tanker configuration 200. This tanker configuration is a less expensive setup than the separate loading and unloading valves 51 shown on tanker configuration 201. Therefore in addition to the benefits of crossover protection and the extended life of flow valve assembly 50 there is also the benefit of standardizing on the lower cost tanker configuration 200. Tanker configuration 200 is also a simpler solution for tagging and crossover protection since only one flow valve assembly is used with a single set of tagging rings. The additional tagging adapter camlocks 100 used on trailer configuration 201 are not required.

FIG. 13A shows an enlarged exploded view of FIG. 13 showing multiple load only API valves 51 with replaceable flanges 60 configured for various types of fuel with interlock recesses 61X, 61Y and 61Z plus separate unloading valves 90 configured for the same fuels using tag adapter camlocks 100 with interlock recesses 101X, 101Y and 101Z connected to elbows 91. The tag adapter camlocks 100 also show alignment recesses 102X, 102Y and 102Z which are provided as a visual reference to indicate the location or rotational orientation of the interlock recesses 101X, 101Y and 101Z respectively when the female hose coupler 120 is installed and covers the recesses 101. A replaceable flange 60 must be installed on the valve body 59 to complete the flow valve assembly 51 before any fuel can be loaded into the tanker. The replaceable flange 60 and tag adapter camlocks 100 remain in place on the flow valve 51 and unloading valve elbows 91 at all times and until all fuel is unloaded and the tanker returns to the terminal for another load of fuel. Only when the tanker is empty and at the terminal will the replaceable flanges 60 and tag adapter camlocks 100 be removed and replaced with replaceable flanges and tag adapter camlocks configured for different fuels. Of course if the tanker compartments will be filled with the same fuels as on the last run then there is no need to remove the replaceable flanges 60 or tag adapter camlocks 100 since the flow valves are already configured correctly.

Although not shown, the unloading valves 90 or unloading valve elbows 91 could also be modified to use the replaceable flange method of fuel tagging.

FIG. 14 shows a close up exploded view of one load/unload API valve 50, as used on tanker 200, configured for Diesel fuel with a Diesel tagging ring 60. Prior to loading fuel into the tanker compartment a replaceable flange 60, configured for Diesel with interlock recesses 61Y, is installed and preferably locked on the flow valve body 59. The bottom loading couplers 80 on the terminal loading arms (not shown) are all preconfigured with protrusion configurations 81 unique to each type of fuel stored at the terminal. Only the bottom load coupler 80 preconfigured for Diesel with interlock protrusions 81Y will mate with the flow valve 50 configured with a Diesel tagging ring 60. This creates a physical barrier that prevents a bottom loading coupler configured for any other type of fuel from mating with this Diesel tagged flow valve 50. Other tanker compartment flow valves are similarly tagged and loaded with the appropriate fuel. The flow of fuel into the tanker compartment (not shown) is identified by arrow 70. The replaceable flanges or tagging rings are left in place on the flow valves and can be capped for transport with standard camlock dust caps (not shown).

At the service station the driver will only have pre-configured drop adapters 110, drop elbows 150 and hose assemblies 120,130,140 for each type of fuel to be unloaded. Drop adapters 110, drop elbows 150 and hose assemblies for Regular, Premium, Diesel and other fuels are not interchangeable with each other. As shown in FIG. 15 only the Diesel configured hose fitting 120 (on hose 130) with interlock protrusions 121Y will fit on the Diesel configured drop adapter 110 with interlock recesses 111Y and only the Diesel configured drop elbow 150 with interlock protrusions 151Y will fit between the Diesel hose fitting 140 (on hose 130) with interlock recesses 141Y and the top seal connection 160 on the underground storage tank with interlock recesses 161Y. The flow of fuel from the tanker compartment (not shown) is identified by arrow 71. Drop adapter 110 with its interlock protrusions 112Y also shows the location of the alignment protrusions 113Y on the outside surface of the drop adapter to visually aid in the rotational alignment of the drop adapter for assembly and disassembly from the replaceable flange 60.

FIG. 16 shows a close up exploded view of one load only flow valve 51 as used on tanker 201 configured for Diesel fuel with a Diesel tagging ring 60. Prior to loading fuel into the tanker compartment a replaceable flange 60 configured for Diesel with interlock recesses 61Y is installed on the flow valve body 59. The separate load and unloading configuration shown on tanker 201 requires the additional camlock tag adapter 100 with interlock recesses 101Y for unloading. Both tags (tagging ring 60 and tag adapter 100) are installed and preferably locked to the flow valve body 59 and unloading valve elbow 91 respectively. The bottom loading couplers 80 on the terminal loading arms (not shown) are all preconfigured with protrusion configurations 81 unique to each type of fuel stored at the terminal. Only the bottom load coupler 80, configured for Diesel with interlock protrusions 81Y, will mate with the flow valve 51 configured with a Diesel tagging ring 60. This creates a physical barrier that prevents a bottom loading coupler configured for any other type of fuel from mating with this Diesel tagged flow valve 51. Other tanker compartment flow valves are similarly tagged and loaded with the appropriate fuel. The flow of fuel into the tanker compartment (not shown) is identified by arrow 70. The replaceable flanges or tagging rings are left in place on the flow valves and can be capped for transport with standard camlock dust caps (not shown).

At the service station the driver will only have pre-configured drop elbows 150 and hose assemblies 120, 130, 140 for each type of fuel to be unloaded. Drop elbows 150 and hose assemblies for Regular, Premium, Diesel and other fuels are not interchangeable with each other. As shown in FIG. 16 only the Diesel configured hose fitting 120 (on hose 130) with protrusions 121Y will fit on the Diesel configured camlock tag adapter 100 with recesses 101Y and only a Diesel configured drop elbow 150 will fit between the Diesel hose fitting 140 (on hose 130) with recesses 141Y and the Diesel top seal connection 160 on the underground storage tank with recesses 161Y. The flow of fuel from the tanker compartment (not shown) is identified by arrow 71.

The X, Y, Z recess and protrusion configurations and any other required configurations for other fuels would be standardized industry wide. With a standard in place the first step would be to replace gas station tank top seal adapters 160 with top seal adapters configured with recesses particular to the fuel to be stored in that tank. Since the system is backwards compatible with standard camlock fittings there will be no interruption in fuel delivery service if tankers are still operating without configured adapters, hose assemblies and drop elbows. Tankers typically carry multiple sets of hoses and fittings, one set for each fuel delivered. Therefore the quantity of hose and fittings can be the same only now they are configured for a particular fuel. There is also no appreciable change in procedures for loading and unloading fuel except that there is now positive feedback when a connection is attempted between say a Diesel and Premium configured fitting. Since adapters, hose assemblies and drop elbows configured for different fuels are not compatible with each other and will not physically fit together the potential for crossovers is prevented.

FIG. 17 shows an exploded view of an additional embodiment of a flow valve 300 which includes a flow valve body portion 301 that contains the mechanics and sealing systems of the flow valve and a replaceable flange 310.

The body portion 301 is cast and/or machined without a flange. In place of the flange an annular mounting surface 305 is machined into the flow valve body 301. The annular mounting surface 305 includes openings for spring load latches 303 protruding from surface 305. The latches are sized to accept axial movement of the inner annular surface 313 of the replaceable flange 310 by retracting during axial assembly of replaceable flange 310 onto the flow valve body surface 305. When the inner face 315 of the replaceable flange 310 contacts the annular surface 306 of flow valve body 301 the spring loaded latches 303 are released by spring force and engage slot 312 in the replaceable flange 310 thereby locking the ring in place on the valve body 301.

The valve body 301 can also include a key 302 that communicates with a slot 314 in the replaceable flange 310 to ensure the preferred orientation of the recesses 311 is maintained.

The embodiments described are not meant to limit the scope of the invention. Many other methods and configurations of attaching and locking a replaceable flange to the flow valve body are possible within the scope of the invention. Similarly, there are also many other configurations and shapes of the protrusions and recesses that are possible within the scope of the invention.

1. A flow valve for mating with a female coupling comprising:
a generally annular flange member having components for mounting said annular flange member;
a generally cylindrical flow valve body member having opposed ends, one of the opposed ends of said flow valve body member defining a leading end having cooperating components to mount said annular flange member;
a flow valve member comprising said annular flange member mounted to said flow valve body member;
a female coupling member defining an opening into which a leading end of said flow valve member can be inserted so that the flow valve member is moved longitudinally of an axis of the female coupling member into the opening to a locking position;
the flow valve member and female coupling member defining a duct passing therethrough for communication of a fluid therebetween;
a locking arrangement for locking the flow valve member in the female coupling member at the locking position;
wherein the locking arrangement includes a plurality of circumferentially spaced locking members within a respective side opening of the female coupling member for movement radially inwardly of the axis of the female coupling member into locking engagement with a portion of the annular flange member;
cooperating components provided on an inside surface of said female coupling member and on an outside surface of said annular flange member;
said cooperating components comprising at least one protrusion provided on either an inside surface of the female coupling member or on an outside surface of the annular flange member;
said cooperating components comprising at least one recess provided on either an inside surface of the female coupling member or on an outside surface of the annular flange member;
said cooperating components defined by said at least one recess and said at least one protrusion being cooperatively shaped and arranged to allow insertion of the flow valve member into the female coupling member to the locking position when said at least one recess and said at least one protrusion match.

2. The flow valve and female coupling according to claim 1 wherein the cooperating components comprise a plurality of protrusions and a plurality of recesses at a predetermined spacing therebetween and wherein insertion of the flow valve member into the female coupling member to the locking position is allowed only when said predetermined spacing matches.

3. The flow valve and female coupling according to any one of claims 1 to 2 wherein there are provided elements visually identifying the location of the protrusions and recesses when the flow valve member and the female coupling member are connected and when they are separated so as to ensure alignment when relative movement is undertaken.

4. The flow valve and female coupling according to any one of claims 1 to 3 wherein said cooperating component on the outside surface of the annular flange member is located at said leading end of the male flow valve member.

5. The flow valve according to any one of claims 1 to 4 wherein said annular flange member is symmetric to facilitate reversible repositioning of said annular flange member so as to distribute wear caused by the circumferentially spaced locking members of the female coupling member.

6. The flow valve according to any one of claims 1 to 4 wherein said annular flange member is symmetric to facilitate rotatable repositioning of said annular flange so as to distribute wear caused by the circumferentially spaced locking members of the female coupling member.

7. A method of delivering a plurality of different fluids comprising:
providing for each fluid a respective delivery duct;
providing in each delivery duct a flow valve and female coupling according to any one of claims 1 to 6;
and arranging said at least one protrusion and said at least one recess of a first one delivery duct to have a different configuration from that of a second one of the delivery ducts to prevent interchangeability of the first and second delivery ducts at the flow valve and female coupling.
